(19) United States
(12) Patent Application Publication
(10) Pub. No.: US 2023/0202719 A1
(43) Pub. Date: Jun. 29, 2023

(54) Systems and Methods for Retention and Access for Storage Containers

(71) Applicant: DND Innovative Solutions, Inc., Ottawa, IL (US)

(72) Inventor: Darrell Wayne Fleming, Ottawa, IL (US)

(21) Appl. No.: 17/975,746

(22) Filed: Oct. 28, 2022

Related U.S. Application Data
(60) Provisional application No. 63/272,966, filed on Oct. 28, 2021.

(51) Int. Cl. B65D 25/54; B65D 25/00; B65D 25/20

(52) U.S. Cl. CPC B65D 25/54; B65D 25/005; B65D 25/20

(57) ABSTRACT

Systems and methods for retention and access to storage containers, including a flexible sidewall that is configured to be removably attached to an open side of a storage container. A retention and access system may be configured to be repositioned to increase a size of an opening into the container in order to access items stored lower down within the container.

### CROSS REFERENCE TO RELATED APPLICATIONS

The present application is a US Non-provisional application claiming priority to U.S. Provisional Application No. 63/272,966, entitled “Systems and Methods for Retention and Access for Storage Containers,” filed Oct. 28, 2021. The prior application is incorporated by reference herein in its entirety.

### BACKGROUND

Certain storage containers configured to be used in warehousing environments may have a three-sided structure with one open side configured to facilitate access to items stored therein. However, stored items may become dislodged and fall out from the storage container during transport or unloading. This represents a potential hazard, and/or may result in damage to the stored items. Accordingly, a need exists for a retention and access system configured to allow items to be securely retained within such a storage container, while facilitating easy access and removal of said items when desired. Aspects of this disclosure relate to improved retention and access systems for storage containers.

### BRIEF SUMMARY

Aspects of this disclosure relate to improved retention and access systems for increasing and/or maximizing a volume of merchandise that can be transported in a storage container from one area to another. This, in turn, may increase production efficiency in a supply chain of an industrial environment and/or storage efficiency in non-industrial environments.

According to one aspect, a retention and access system for a storage container includes a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also include a top sleeve that is flexibly attached to the top edge of the panel, and an elastic cord that is configured to extend through the top sleeve. The elastic cord may have a first coupler at a first end and a second coupler at a second end, with the first coupler configured to be removably attached to a first portion of a left side of the container, and the second coupler configured to be removably attached to a second portion of a right side of the container. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and not limited in the accompanying figures in which like reference numerals indicate similar elements and in which:

FIGS. 1A-1D schematically depict orthographic projections of a storage container, according to one or more aspects described herein;

FIG. 2 schematically depicts the flexible sidewall, according to one or more aspects described herein;

FIG. 3 schematically depicts an isometric view of the container of FIGS. 1A-1D, according to one or more aspects described herein;

FIG. 4 schematically depicts an isometric view of a container to which a retention and access system is removably coupled, according to one or more aspects described herein;

FIG. 5 schematically depicts an isometric view of a container to which a retention and access system is removably coupled, with a flexible sidewall of the retention and access system in a partially open configuration, according to one or more aspects described herein;

FIG. 6 schematically depicts an isometric view of a container to which a retention and access system is removably coupled, with a flexible sidewall of the retention and access system in a closed configuration, according to one or more aspects described herein;

FIG. 7 schematically depicts an isometric view of an alternative implementation of a flexible sidewall that is removably coupled to a storage container, according to one or more aspects described herein;

FIG. 8 schematically depicts an isometric view of an alternative implementation of a flexible sidewall that is removably coupled to a storage container, according to one or more aspects described herein;

FIG. 9 schematically depicts the flexible sidewall of FIG. 8 in a partially open configuration, according to one or more aspects described herein;

FIG. 10 schematically depicts an isometric view of an alternative implementation of a flexible sidewall that is removably coupled to a storage container, according to one or more aspects described herein;

FIG. 11 schematically depicts the flexible sidewall of FIG. 10 in a partially open configuration, according to one or more aspects described herein;

FIG. 12 schematically depicts an isometric view of an alternative implementation of a flexible sidewall that is removably coupled to a storage container, according to one or more aspects described herein;

FIG. 13 schematically depicts the flexible sidewall of FIG. 12 in a partially open configuration, according to one or more aspects described herein;

FIGS. 14A-14B schematically depict isometric views of a portion of the flexible sidewall of FIG. 2, according to one or more aspects described herein;

FIG. 15 schematically depicts a portion of the right wall of the container of FIG. 1 and a portion of the flexible sidewall of FIG. 2, according to one or more aspects described herein;

FIG. 16 schematically depicts another implementation of a portion of the right wall of the container of FIG. 1 and a portion of the flexible sidewall of FIG. 2, according to one or more aspects described herein;

FIG. 17 schematically depicts another implementation of a portion of the right wall of the container of FIG. 1 and a portion of the flexible sidewall of FIG. 2, according to one or more aspects described herein;

FIG. 18 schematically depicts another implementation of a portion of the right wall of the container of FIG. 1 and a portion of the flexible sidewall of FIG. 2, according to one or more aspects described herein;

FIG. 19 schematically depicts in another implementation of a flexible sidewall, according to one or more aspects described herein;

FIG. 20 schematically depicts in another implementation of a flexible sidewall, according to one or more aspects described herein;

FIG. 21 depicts a container to which a retention and access system is removably coupled, according to one or more aspects described herein;

FIG. 22 depicts another implementation of a flexible sidewall, according to one or more aspects described herein;

FIG. 23 depicts a more detailed view of a portion of the flexible sidewall of FIG. 22, according to one or more aspects described herein.

Further, it is to be understood that the drawings may represent the scale of different component of one single embodiment; however, the disclosed embodiments are not limited to that particular scale.

### DETAILED DESCRIPTION

Exemplary embodiments are shown in the drawings and will herein be described in detail with the understanding that the present disclosure is to be considered as an exemplification, and is not intended to be limited to the embodiments illustrated. It is to be understood that other embodiments may be utilized, and structural and functional modifications may be made, without departing from the scope and spirit of the present disclosure.

In the following description of the various embodiments, reference is made to the accompanying drawings, which form a part hereof, and in which is shown by way of illustration, various embodiments of the disclosure that may be practiced. It is to be understood that other embodiments may be utilized.

In the following description of various example structures, reference is made to the accompanying drawings, which form a part hereof, and in which are shown by way of illustration various example devices, systems, and environments in which aspects of the disclosures herein may be practiced. It is to be understood that other specific arrangements of parts, example devices, systems, and environments may be utilized and structural and functional modifications may be made without departing from the scope of the present disclosures. Also, while the terms “top,” “bottom,” “front,” “back,” “side,” “rear,” “upward,” “downward,” and the like may be used in this specification to describe various example features and elements, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of these disclosures. Also, the reader is advised that the attached drawings are not necessarily drawn to scale.

In general, aspects of this disclosure relate to retention and access systems and methods for production of a retention and access system. According to various aspects and embodiments, the retention and access system may be formed of one or more of a variety of materials, such as metals (including metal alloys), plastics, polymers, and composites, and may be formed in one of a variety of configurations, without departing from the scope of these disclosures.

The various figures in this application illustrate examples of retention and access systems according to this disclosure. When the same reference number appears in more than one drawing, that reference number is used consistently in this specification and the drawings refer to the same or similar parts throughout.

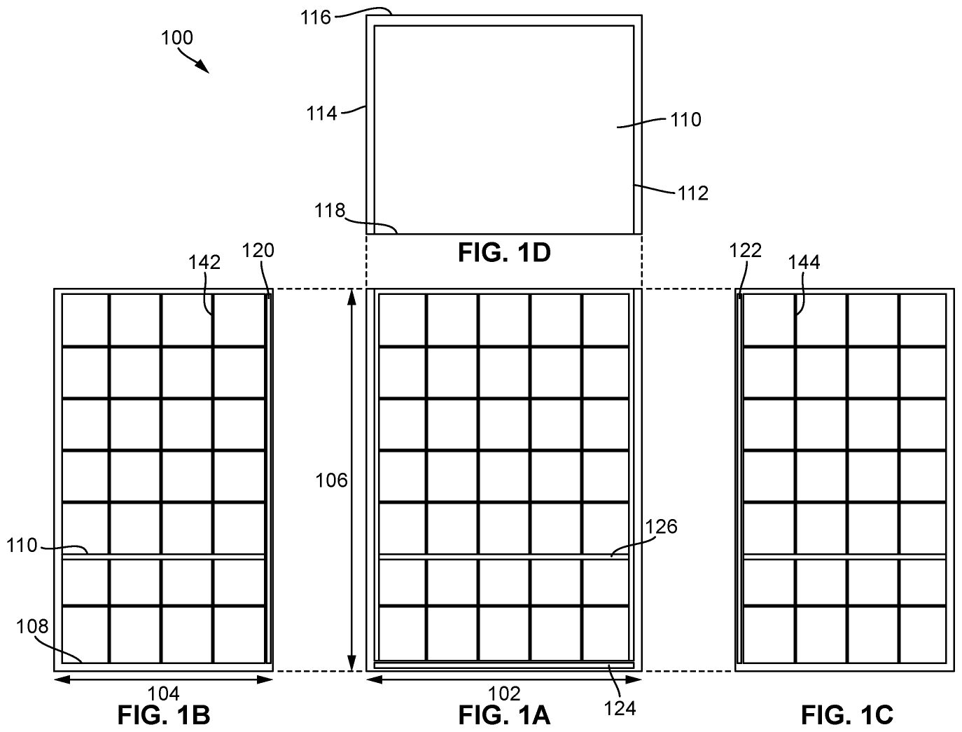

FIG. 1A-1D schematically depict orthographic projections of a storage container 100 to which a retention and access system described in the proceeding disclosure may be applied/affixed. FIG. 1A depicts an elevation view of the storage container 100. FIGS. 1B and 1C depict left and right side views of the storage container 100, respectively. FIG. 1D depicts a plan view of the storage container 100. It is contemplated that the various structures described throughout this disclosure may be implemented with different geometries and/or dimensional values. The storage container 100 is one example of a structure to which the retention and access system may be affixed. In one implementation, the storage container 100 may be formed as a metallic structure from square, rectangular, or circular steel tubing. However, additional or alternative materials may be utilized, such as wood, polymers, among others, to form the storage container 100. It is contemplated that the spacing between the various structural members may have any values. The storage container 100 may have a width 102, a depth 104, and a height 106. However, the container 100 may have additional geometrical properties, without departing from the scope of these disclosures. Products may be stacked within the storage container 100 on a base surface 108. This base surface 108 may be formed as a solid surface or may have an array of openings extending through the surface 108. The container 100 may additionally include a shelf 110 that may be positioned and repositioned at different heights within the container 100. Similarly to the base 108, the shelf 110 may be solid or may have openings that extend through a surface of the shelf 110. It is contemplated that the storage container 100 may include multiple shelves similar to shelf 110. It is further contemplated that the storage container 100 may additionally or alternatively include different storage bins or other receptacles for storing goods/items. In one example, the base 108 may include elements configured to receive a fork of a forklift truck, such that the container 100 may be transported/moved by a forklift truck. The container 100 may be configured with an open top, and three walls 112, 114, and 116. As such, the container may have an open side 118, with this open side allowing goods to be loaded into/unloaded from the container 100. Advantageously, the retention and access system described in the proceeding disclosure provides a flexible structure that prevents goods from falling out from the storage container 100 through the open side 118, while also facilitating easy access to those goods.

The retention and access system described in this disclosure may be removably coupled to the storage container 100 using a left side container attachment strip 120, otherwise referred to as a left side container attachment 120, and a right side container attachment strip 122, otherwise referred to as a right side container attachment 122. The left side container attachment strip 120 may be coupled to and extend along a left edge of the open side 118 of the storage container 100. Similarly, the right-side container attachment strip 122 may be coupled to and extend along a right edge of the open side 118 of the storage container 100. The coupling mechanism of the strips 120 and 122 may include hook and loop fasteners, magnets, zippers, snaps, among others. It is contemplated that the use of the terms magnet and/or magnetic may refer to a permanent magnet, a material that may be magnetized, and/or a ferromagnetic material that is attracted to a magnet when used throughout these disclosures. These strips 120 and 122 may be implemented as continuous strips along the full height 106 of the container 100, or may extend along a portion of the height 106. Further, one or more of the strips 120 and 122 may be implemented as multiple discrete elements spaced along all or a portion of the height 106. A bottom side container attachment strip 124 may be affixed to and extend along a bottom edge of the open side 118 of the container 100. This bottom side container attachment strip 124 may be similar to strips 120 and 122. Further, the bottom side container attachment strip 124 may extend along a full width 102, or a portion of the width 102. Additionally or alternatively, the container 100 may include a shelf attachment strip 126. This shelf attachment strip 126 may be similar to the bottom side container attachment strip 124, and may extend along a front edge of the shelf 110. In certain examples, the shelf attachment strip 126 may be affixed to an underside of the shelf 110, or to a surface of the shelf 110 facing outward from the container 100. In one example, the strips 120, 122, 124 and/or 126 may be removably coupled to a flexible sidewall 200 to form a retention and access system.

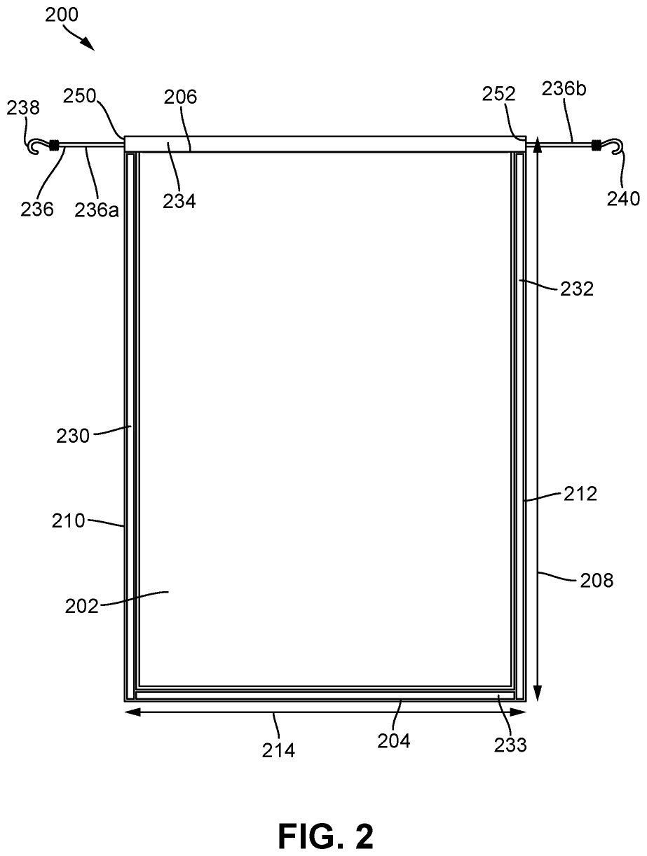

FIG. 2 schematically depicts the flexible sidewall 200, according to one or more aspects described herein. Accordingly, the flexible sidewall 200 may be configured to be removably coupled to the open side 118 of the storage container 100. The flexible sidewall 200 may include a panel 202. The panel 202 may have a bottom edge 204 spaced apart from a top edge 206 by a panel height/length 208, and a left edge 210 spaced apart from a right edge 212 by a panel width 214. The panel 202 may be implemented with any height 208 and width 214. In one example, the width 214 may be at least equal to width 102 of the container 100. In certain examples, the width 214 may be greater than the width 102 such that portions of the panel 202 may extend around to the sides of the container 100 and interact/removably couple with the strips 120 and 122. The height 208 may be at least equal to the height 106. In other examples, the height 208 may be less than or greater than the height 106. In certain specific examples, the width 214 may be 52 inches, or may range between 45 and 60 inches. The height 208 may range between 30 and 70 inches. However, it is contemplated that the flexible sidewall 200 may be sized to fit different opening geometries of storage containers similar to container 100, without departing from the scope of these disclosures.

The flexible sidewall 200 may additionally include a left side panel attachment strip 230, otherwise referred to as a left side panel attachment 230, that is flexibly coupled to the left edge 210, and a right side panel attachment strip 232, otherwise referred to as a right side panel attachment 232, that is flexibly coupled to the right edge 212 of the sidewall 200. It is contemplated that any coupling mechanism or methodology may be utilized throughout this disclosure to facilitate rigid or flexible coupling, such as sewing, fabric welding, riveting, stapling, screwing, nailing, gluing, among others. The sidewall 200 may additionally include a bottom side panel attachment strip 233 that is flexibly coupled to the bottom edge 204. The attachment strips 230 and 232, may be configured to be removably coupled to the attachment strips 120 and 122, respectively. The attachment strip 233 may be configured to be removably coupled to the attachment strip 124 and/or 126. Accordingly, the attachment strips 230, 232, and 233 may be implemented with the same attachment mechanism as the strips 120, 122, 124 and 126. The attachment strips 230, 232, and 233 may be hook and loop fasteners, magnetic strips/discrete magnetic elements spaced apart along the strips 230, 232, and 233, zippers or snaps, among others. It is further contemplated that attachment strips 230, 232, and 233 may use differing fastening elements, without departing from the scope of these disclosures. For example, attachment strips 230 and 232 may utilize hook and loop fasteners to removably couple to attachment strips 120 and 122, and attachment strip 233 may use a magnetic strip to attach to a magnetic strip of the attachment strip 124 or 126. In one example, if a magnetic strip is used in one or more of attachment strips 230, 232, and/or 233, the container 100 may not need to be outfitted with a corresponding attachment strip 120, 122, 124 and/or 126 if the container 100 is formed from a magnetic material such that the magnetic strip of one or more of the attachment strips 230, 232, and/or 233 may be magnetically coupled directly to the container 100.

The sidewall 200 may also include a top sleeve 234 that is flexibly coupled to the top edge 206. This top sleeve may comprise a channel through which an attachment element may be received. In one example, this attachment element may include an elastic cord 236 that includes a first coupler 238 at a first end, and a second coupler 240 at a second end. In one example, the first coupler 238 and the second coupler 240 may be hooks. In other examples, the first coupler 238 and second coupler 240 may include spring-loaded swivel bolts, magnetic elements, hook and loop fasteners, snap fasteners, cords configured to be tied to one another around a support structure, or any other removable fastener type. The elastic cord 236 may have any length. The cord 236 may be configured to be removably coupled to the container 100. Specifically, the first coupler 238 may be removably coupled to a first portion of a left side of the container 100, such as one or more of the members that form the left wall 114 of the container 100. Member 142 is one such element (which may be a metal bar/rod) to which the first coupler 238 may be removably coupled. Similarly, the second coupler 240 may be removably coupled to a second portion of a right side of the container 100, which as one or more of the members that form the right wall 112. Member 144 is one such element (which may be a metal bar/rod) to which the second coupler 240 may be removably coupled.

In another implementation, element 234 may be flexible top support panel 234 formed from one or more layers of material that may not be open at one or more ends. Further, the first coupler 238 may be flexibly coupled to the top support panel 234 without extending through the top support panel 234. Similarly, the second coupler 240 may be flexibly coupled to the top support panel 234 without extending through the top support panel 234. Accordingly, the first coupler 238 may be attached to the top support panel 234 at a left side of the top support panel 250, and the second coupler 240 may be attached to the top support panel 234 at a right side of the top support panel 252. As such, the cord 236 may be a single cord that extends between the first coupler 238 and the second coupler 240, or two discrete cord length 236a and 236b.

In one example, the sleeve/top support panel 234 may include a stiffening element that is positioned within the sleeve/panel 234 to prevent the sidewall 200 from sagging when attached to the container 100.

It is contemplated that the structures described throughout this disclosure may be formed from any materials, or combination of materials. Further, the materials may have any material thicknesses, without departing from the scope of these disclosures. In one example, the panel 202 may be formed from a transparent vinyl material. In other examples, the panel may be formed from a partially transparent or opaque material. The material of the panel 202 may include one or more polymers, or canvas materials. It is further contemplated that the panel 202 may be formed from multiple layers of materials.

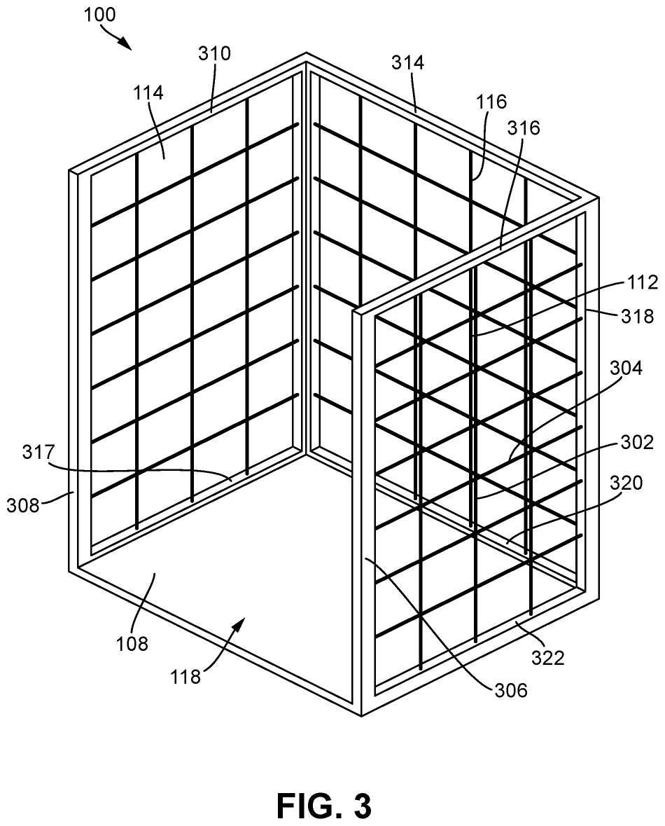

FIG. 3 schematically depicts an isometric view of the container 100, according to one or more aspects described herein. Container 100 may a left wall 114, a right wall 112, and a back wall 116. As depicted, shelf 110 is removed from container 100 and may be removably positioned at different heights within the container 100. It is contemplated that the base surface 108 may extend out beyond the left and right walls 140 and 112. The walls 112, 114, and 116 may be formed from multiple rods that extend horizontally and vertically, with rod 302 an example of a vertical rod and rod 304 an example of a horizontal rod. The number of such rods and spacing therebetween may vary, without departing from the scope of these disclosures. The base surface 108 and/or the shelf 110 (not depicted in FIG. 3) may be solid, or may include openings similar to one or more of the walls 112, 114, and/or 116. The container 100 may additionally include frame elements 306-322 that form the superstructure of the container 100 and to which the vertical and horizontal members (e.g., rods 302 and 304) may be affixed. These frame elements 306-322 may be formed from square, rectangular, or circular rods of a same or differing cross-sectional geometry. In certain examples, the frame elements 306-322 may be similar to the horizontal and vertical members/rods 302 and 304.

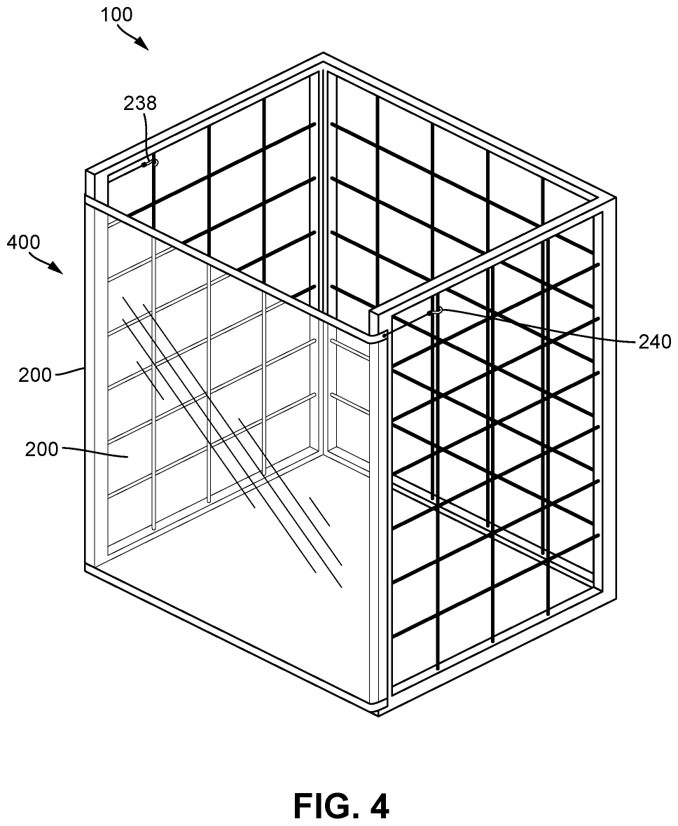

FIG. 4 schematically depicts an isometric view of the container 100 to which the retention and access system 400 is removably coupled, according to one or more aspects described herein. In one example, the retention and access system 400 is formed by the removable coupling of the flexible sidewall 200 to container 100 by one or more of the first coupler 238, the second coupler 240, the left side panel attachment strip 230, the right side panel attachment strip 232, and/or the bottom side panel attachment strip 233. It is contemplated that the first coupler 238, the second coupler 240, the left side panel attachment strip 230, the right side panel attachment strip 232, the bottom side panel attachment strip 233, the left side container attachments strip 120, the right side container attachment strip 122, the bottom side container attachment strip 124, and/or the shelf attachment strip 126 may be implemented with attachment mechanisms that are configured to provide an attachment for sufficient to resist the mass of the goods stored within the container 100. Accordingly, the systems described herein may be utilized with any goods configured to be stored within the container 100.

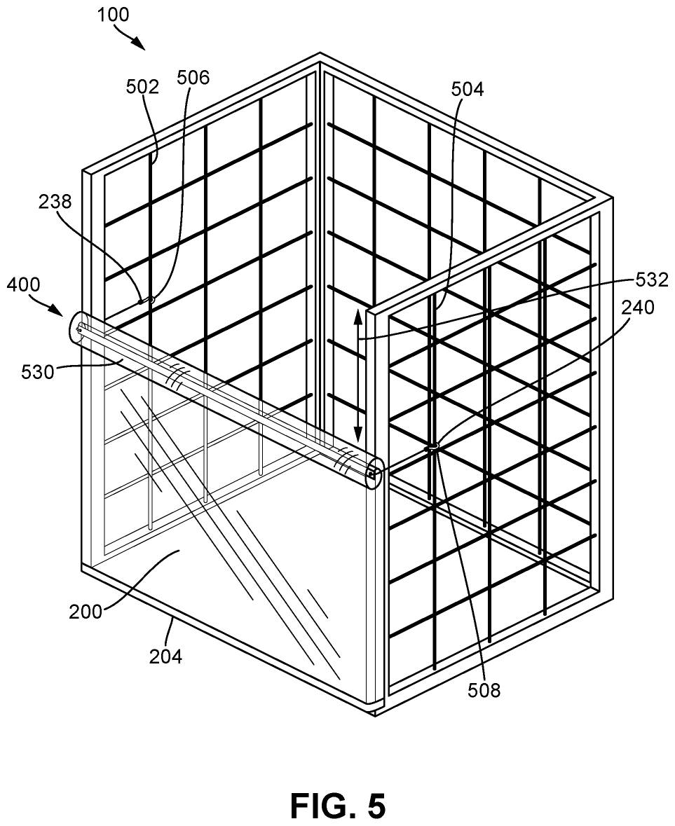

As depicted in FIG. 4, the flexible sidewall 200 extends in a substantially vertical plane. However, it is contemplated that the sidewall 200 may be utilized at different angles, without departing from the scope of these disclosures. As depicted in FIG. 4, the retention and access system 400 is in a fully closed configuration with the flexible sidewall 200 in a fully extended position. In contrast, FIG. 5 schematically depicts an isometric view of the container 100 to which the retention and access system 400 is coupled with the flexible sidewall 200 in a partially open configuration. In order to access items stored lower down within the container 100, a user may uncouple coupler 238 from the first portion 502 of a left side of the container 100 and uncouple coupler 240 from the second portion 504 of the right side of the container 100. The user may then removably couple the coupler 238 to a third portion 506 on a left side of the container 100 and removably couple the coupler 240 to a fourth portion 508 on the right side of the container 100. The positions of the first, second, third and fourth portions 502, 504, 506, and/or 508 may vary, without departing from the scope of these disclosures. When positioned as depicted in FIG. 5, all or a portion of the flexible sidewall 200 may be folded/rolled to form a rolled portion 530, which results in an opening of height 532 to allow for ease of access to items stored toward the bottom of container 100. As depicted in FIG. 5, a portion of the attachment strips 230 and 232 approximately equal to length 532 may be decoupled from corresponding lengths of attachment strips 120 and 122. The remainder of the length of attachment strips 230 and 232 may remain attached to attachment strips 120 and 122.

In other implementations, the flexible sidewall 200 may be positioned in alternative orientations. For example, the flexible sidewall 200 may be positioned at 90° relative to the position depicted in FIG. 5, or as 180° relative to the position depicted in FIG. 5. As such, the flexible sidewall 200 may be configured to be opened from left to right or right to left, rather than from top to bottom as depicted in FIG. 5, or may be configured to be opened from bottom to top, such that the flexible sidewall 200 is decoupled and rolled upward from the bottom 204.

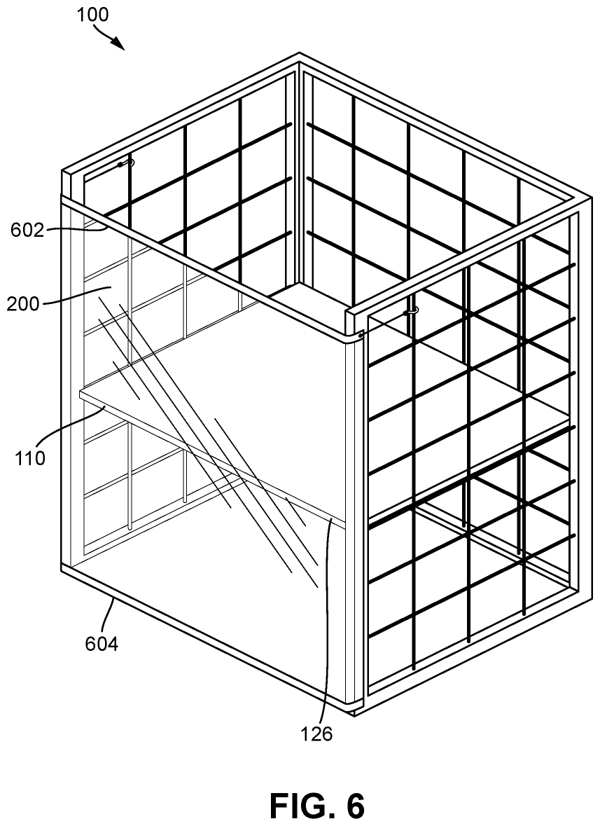

FIG. 6 schematically depicts an isometric view of the storage container 100 with the flexible sidewall 200 removably coupled thereto, according to one or more aspects described herein. In the depicted implementation of FIG. 6, the storage container includes a shelf 110. In one example, the flexible sidewall 200 may extend from a top 602 to a bottom 604 of the container 100. In another example, the flexible sidewall 200 may extend from the top 602 down to the shelf 110.

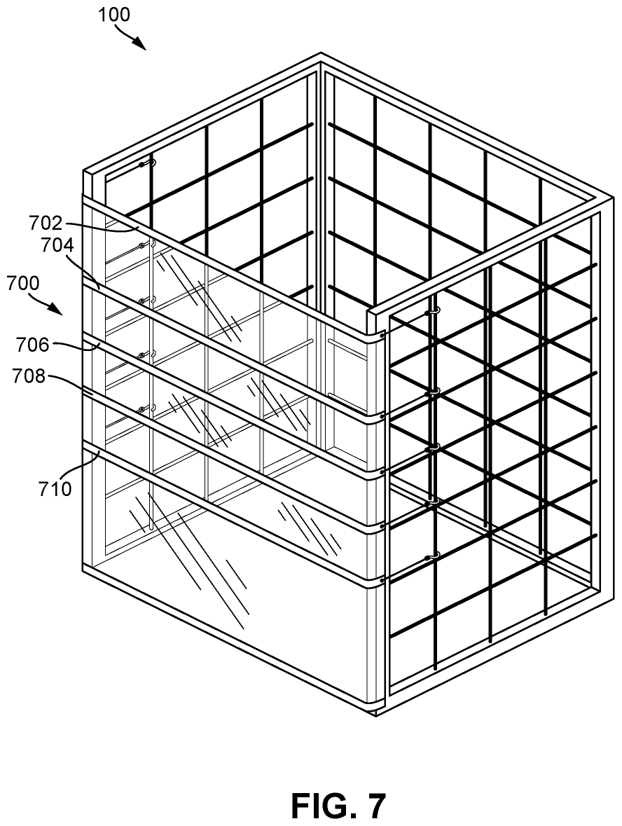

FIG. 7 schematically depicts an isometric view of an alternative implementation of a flexible sidewall 700 that is removably coupled to the storage container 100, according to one or more aspects described herein. The flexible sidewall 700 may be similar to flexible sidewall 200. The flexible sidewall 700 and may be formed from similar materials, and may utilize attachment strips similar to strips 230, 232, and/or 233. However, the flexible sidewall 700 may include multiple panels 702-710 that are similar to panel 234. Accordingly, each of the panels 702-710 may include closures similar to closures 238 and 240. As items are removed from container 100, one or more of the closures associated with panels 702-710 may be removed to increase the size of the opening into the container 100.

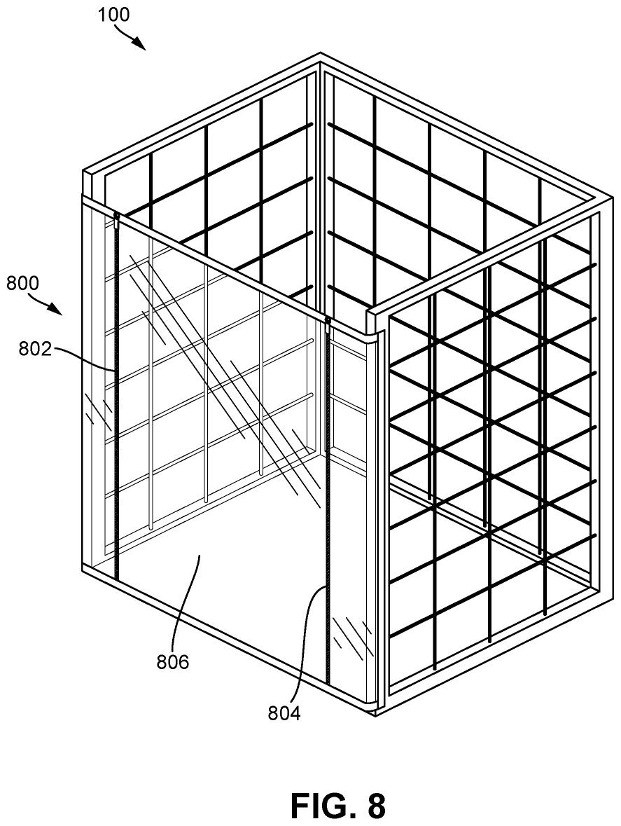

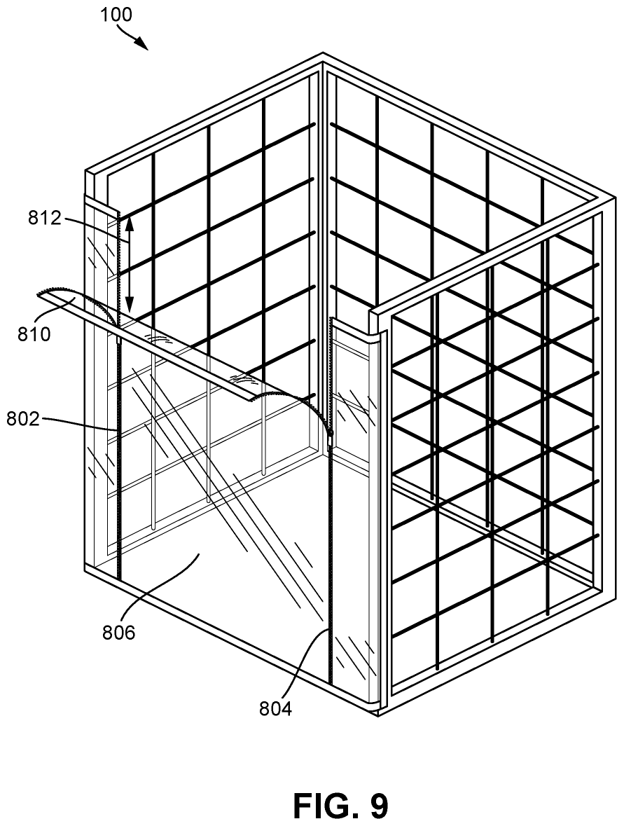

FIG. 8 schematically depicts an isometric view of an alternative implementation of a flexible sidewall 800 that is removably coupled to the storage container 100, according to one or more aspects described herein. The flexible sidewall 800 may be similar to flexible sidewall 200 and formed from similar materials and utilize attachment strips similar to strips 230, 232, and/or 233. Panel 806 may be similar to panel 202. The flexible sidewall 800 may additionally include front closure mechanisms 802 and 804 that extend along a height of panel 806. These front closure mechanisms 802 and 804 may include zippers, snaps, magnetic strips, and/or hook and loop fasteners. In order to increase the size of an opening into the container 100, the closure mechanisms 802 and/or 804 may be actuated. FIG. 9 schematically depicts the flexible sidewall 800 in a partially open configuration with portion 810 of the panel 806 folded to increase an opening to height 812.

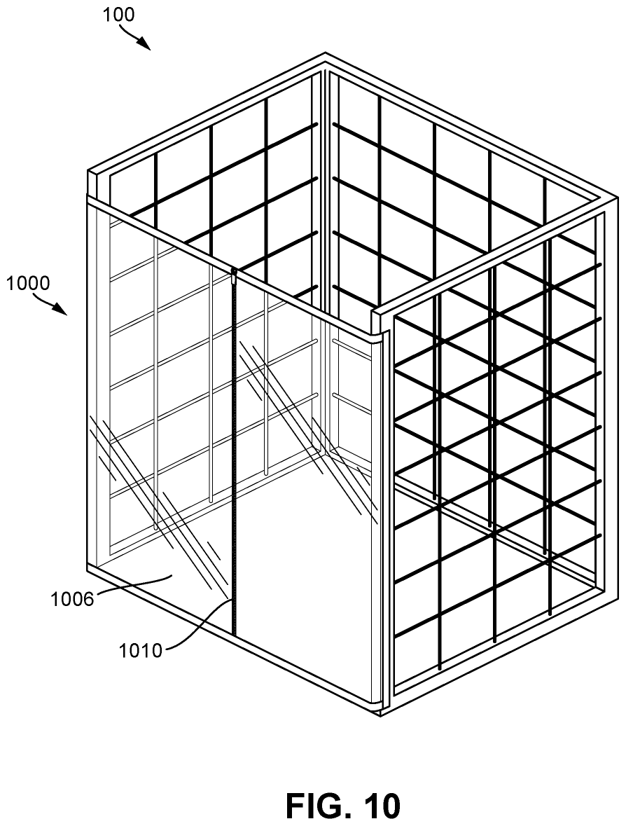

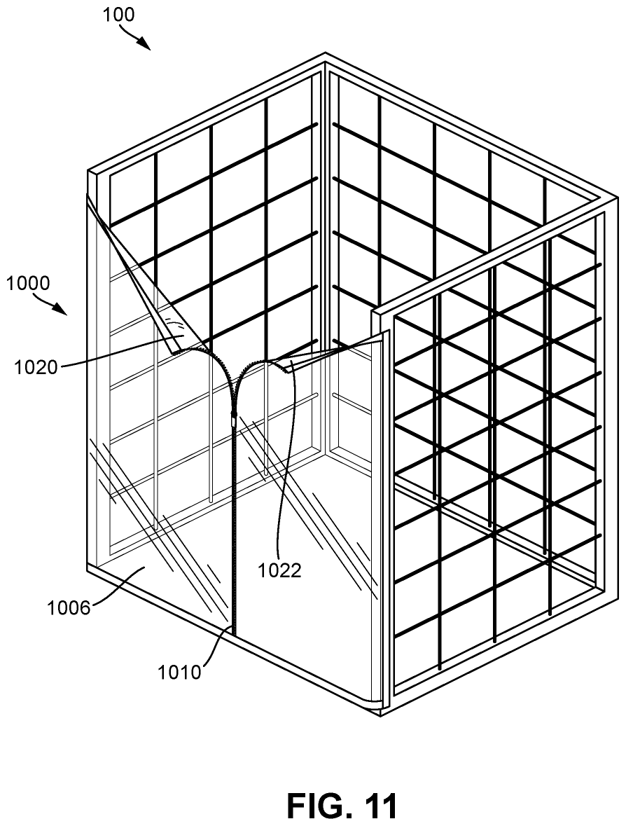

FIG. 10 schematically depicts an isometric view of an alternative implementation of a flexible sidewall 1000 that is removably coupled to the storage container 100, according to one or more aspects described herein. The flexible sidewall 1000 may be similar to flexible sidewall 200 and formed from similar materials and utilize attachment strips similar to strips 230, 232, and/or 233. Panel 1006 may be similar to panel 202. The flexible sidewall 1000 may additionally include a front closure mechanism 1010 that extends along a height of panel 1006. This front closure mechanism 1010 may include a zipper, snaps, magnetic strips, and/or hook and loop fasteners, among others. In order to increase the size of an opening into the container 100, the closure mechanisms 1010 may be actuated. FIG. 11 schematically depicts the flexible sidewall 1000 in a partially open configuration with portions 1020 and 1022 of the panel 1006 folded to increase a size of an opening into container 100.

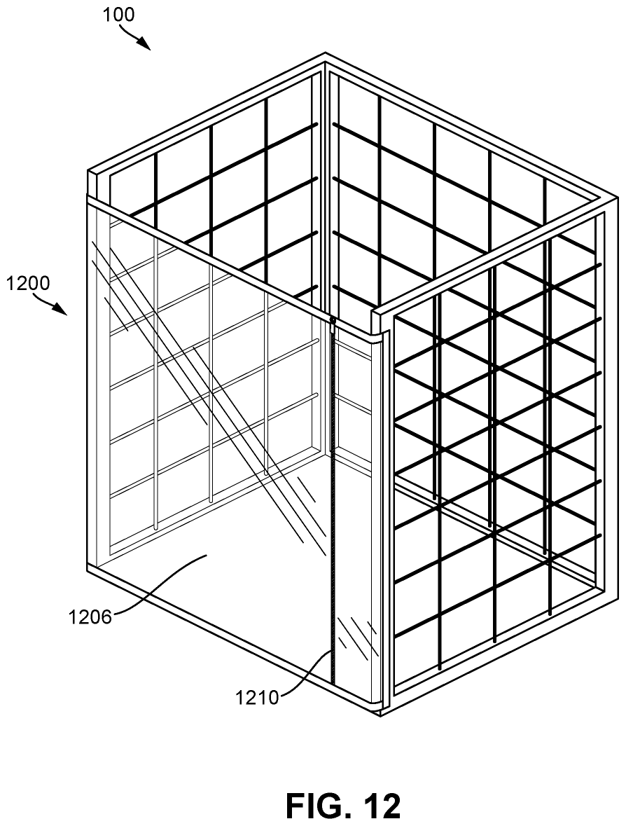

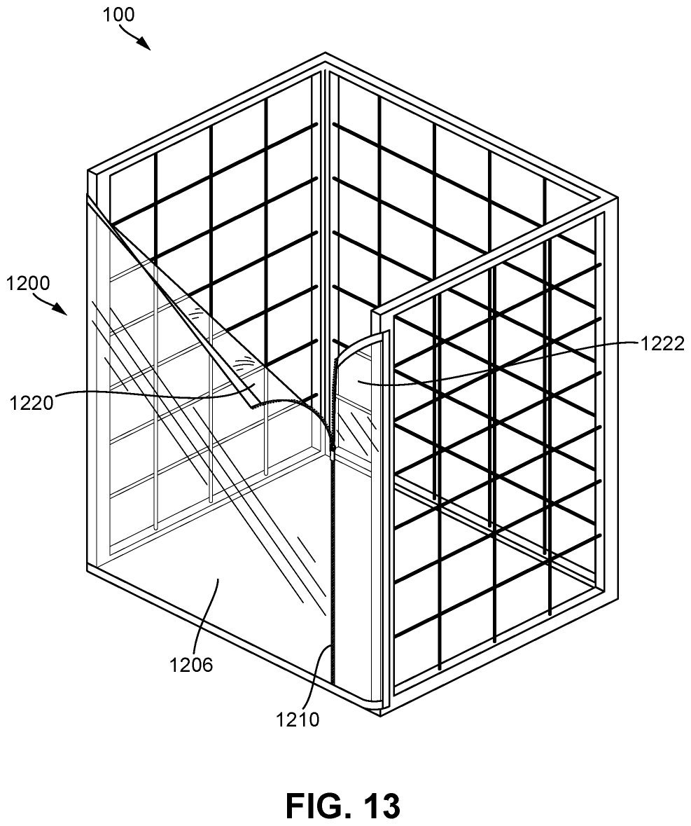

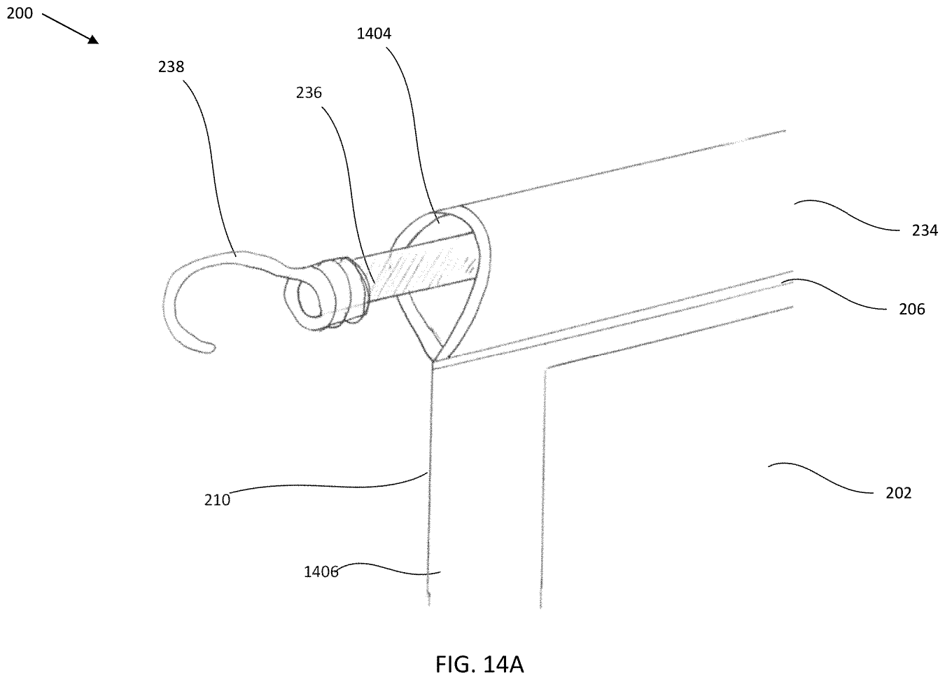

FIG. 10 schematically depicts the closure mechanism 1010 extending approximately along a middle line of the panel 1006. It is contemplated that a similar closure mechanism 1210 may be positioned closer to one side or the other of a middle line of a panel 1206, as depicted in FIGS. 12 and 13. In particular, FIG. 12 schematically depicts an isometric view of an alternative implementation of a flexible sidewall 1200 that is removably coupled to the storage container 100, according to one or more aspects described herein. The flexible sidewall 1200 may be similar to flexible sidewall 200 and formed from similar materials and utilize attachment strips similar to strips 230, 232, and/or 233. Panel 1206 may be similar to panel 202. The flexible sidewall 1200 may additionally include a front closure mechanism 1210 that extends along a height of panel 1206. This front closure mechanism 1210 may include a zipper, snaps, magnetic strips, and/or hook and loop fasteners, among others. In order to increase the size of an opening into the container 100, the closure mechanisms 1210 may be actuated. FIG. 13 schematically depicts the flexible sidewall 1200 in a partially open configuration with portions 1220 and 1222 of the panel 1206 folded to increase a size of an opening into container 100.

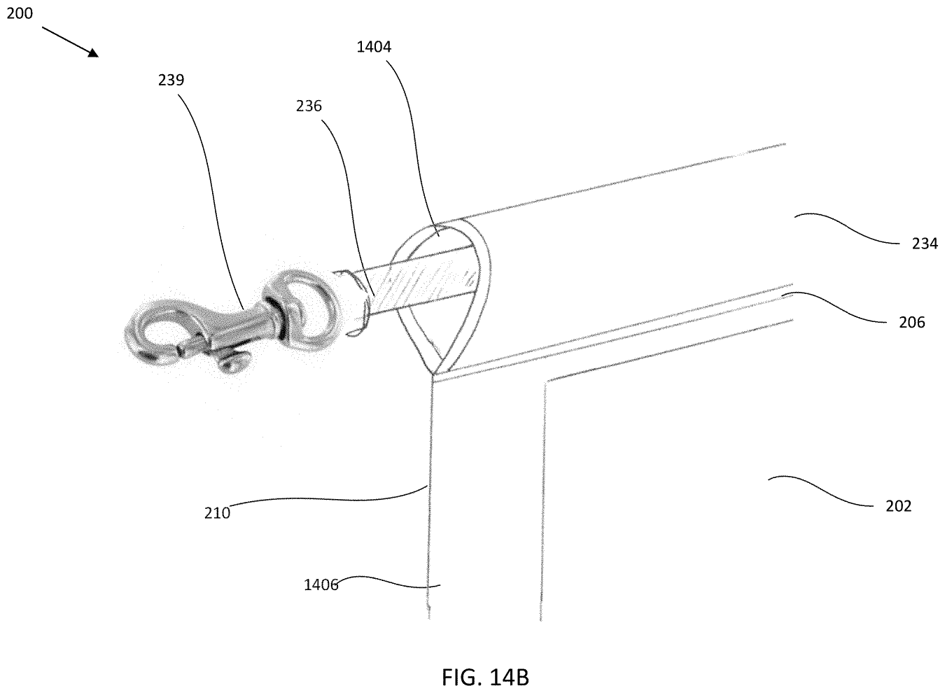

FIG. 14A schematically depicts an isometric view of a portion of the flexible sidewall 200, according to one or more aspects described herein. In one example, FIG. 14A schematically depicts a top left corner of the flexible sidewall 200. The cord 236 may extend through a sheath or sleeve of the top support panel 234. The panel 202 may extend to an edge of the flexible sidewall 200 (e.g. edge 210). Additionally or alternatively, the flexible sidewall 200 may have a piping/edging material panel 1406 that extends around all or part of the flexible sidewall 200. FIG. 14B depicts a similar view of the top left corner of the flexible sidewall 200, but with a spring-loaded swivel bolt 239 in place of the book 238 from FIG. 14A.

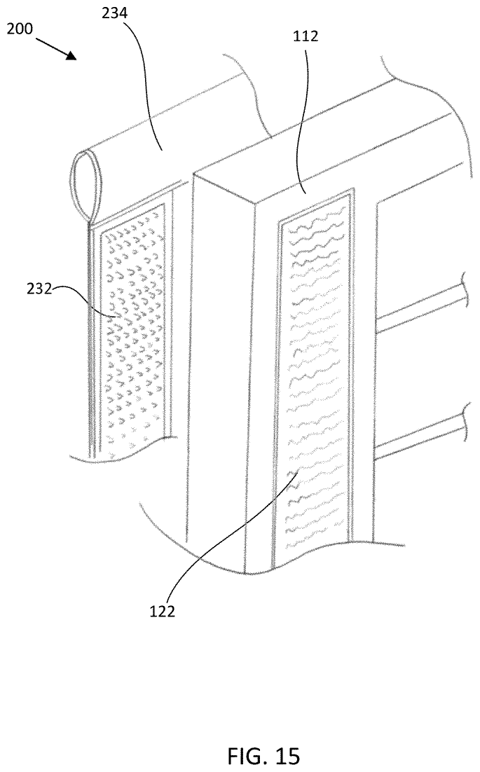

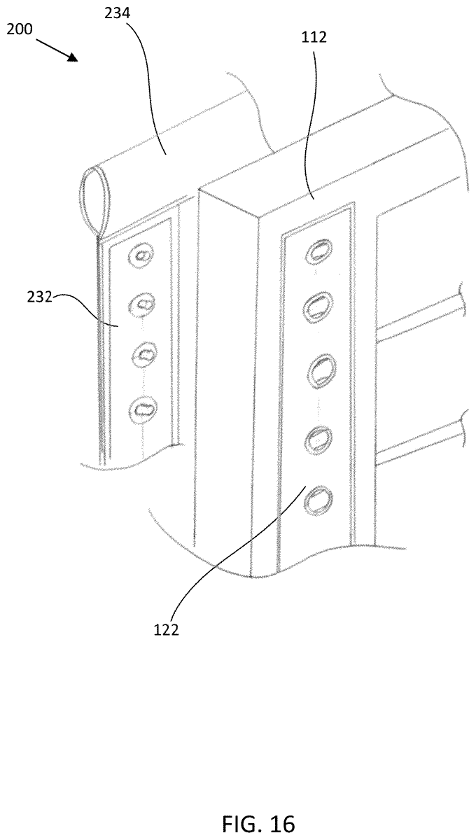

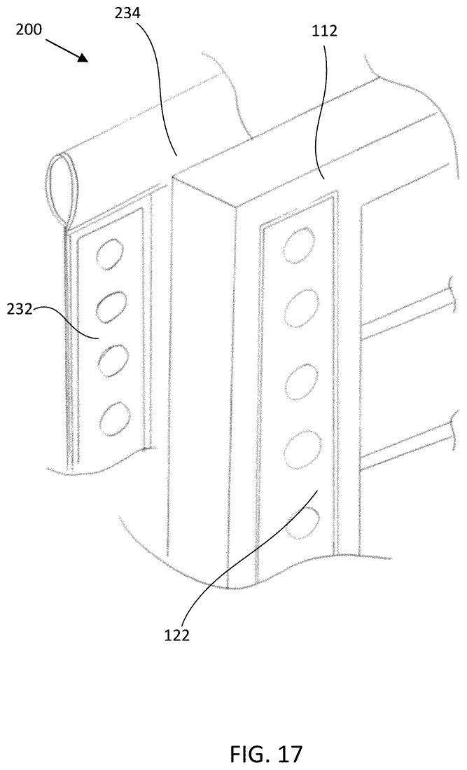

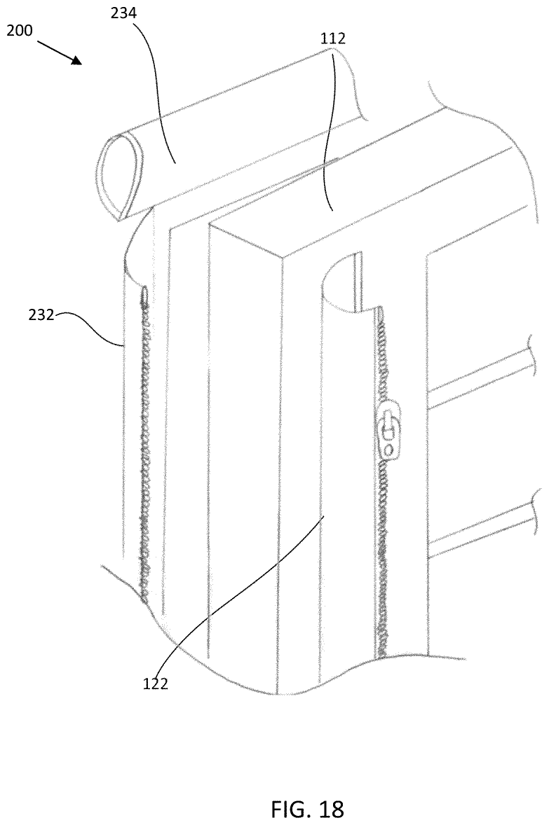

FIG. 15 schematically depicts a portion of the right wall 112 of container 100 and a portion of the flexible sidewall 200, according to one or more aspects described herein. In particular, FIG. 15 schematically depicts a portion of the right side panel attachment strip 232 and the right side container attachment strip 122. As schematically depicted in FIG. 15, the attachment strip 232 comprises hooks of a hook and loop fastener, and the attachment strip 122 comprises loops of the hook and loop fastener. However, in alternative implementations, the attachment strip 232 may comprise loops, and the attachment strip 122 may comprise hooks of a hook and loop fastener, without departing from the scope of these disclosures. FIG. 16 is similar to FIG. 15, and schematically depicts a similar portion of the right wall 112 of container 100 and the flexible sidewall 200. In FIG. 16, the attachment strips 232 and 122 are configured with snap fasteners. It is contemplated that the spacing between the snap fasteners may have any values and that one or more rows of fasteners may be used, without departing from the scope of these disclosures. FIG. 17 is also similar to FIG. 15, and schematically depicts a similar portion of the right wall 112 of container 100 and the flexible sidewall 200. In FIG. 17, the attachment strips 232 and 122 are configured with magnetic fasteners. It is contemplated that the fasteners may include only magnets, or magnets and metallic elements that are attracted to magnets. Further, the spacing between the fasteners may have any values and that one or more rows of fasteners may be used, without departing from the scope of these disclosures. In FIG. 18, the attachment strips 232 and 122 are configured with zipper fasteners.

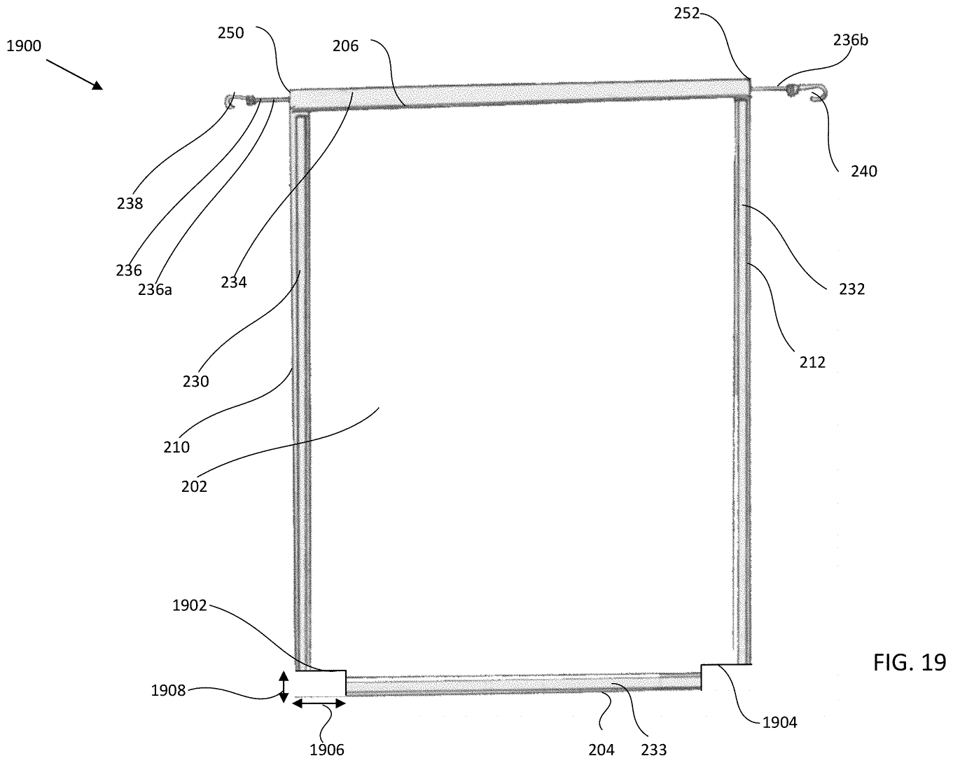

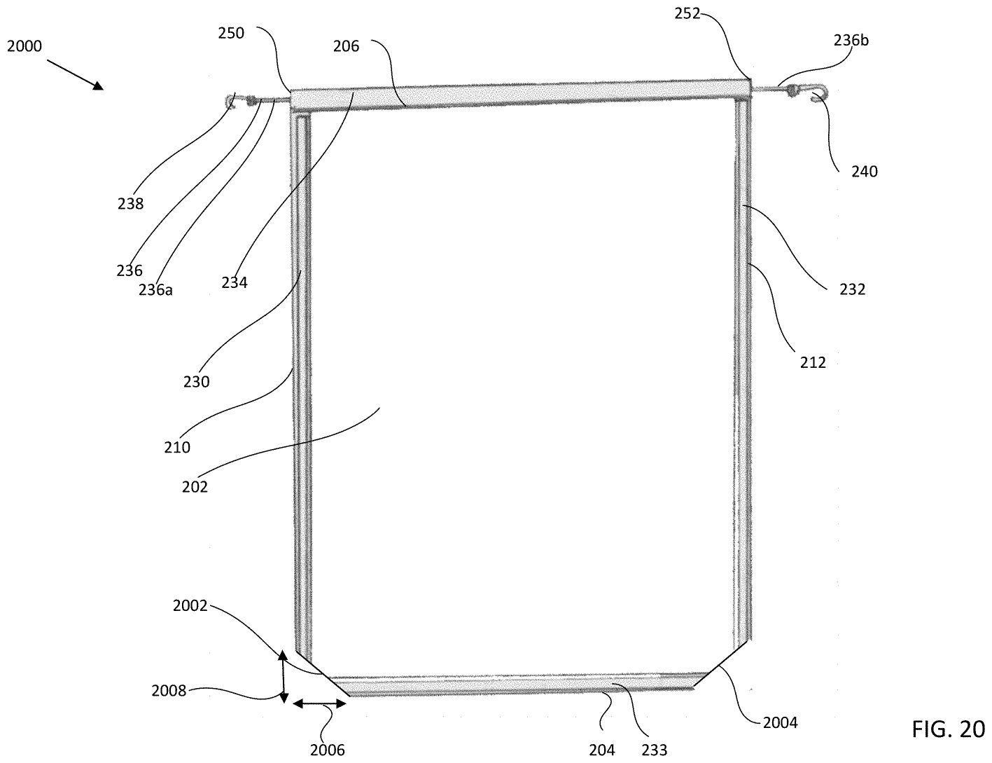

FIG. 19 schematically depicts a flexible sidewall 1900, according to one or more aspects described herein. In one example, the flexible sidewall 1900 may be similar to the flexible sidewall 200, where similar numbers represent similar features of both sidewalls 200 and 1900. The sidewall 1900 additionally includes a left side notch 1902 at a bottom left corner of the flexible sidewall 1900, and a right side notch 1904 at a bottom right corner of the flexible sidewall 1900. The left side notch 1902 and the right side notch 1904 may be configured to fit around a portion of a shelf, such as shelf 110. In one example, each of the left side notch 1902 on the right side notch 1904 may have a length 1906 that measures 2 inches. In another example, length 1906 may range between 0.5 and 5 inches. The left side notch 1902 on the right side notch 1904 may each have a height 1908 that measures 1 inch. In another example, the height 1908 may range between 0.25 and 5 inches. In alternative implementations, a flexible sidewall may utilize notch is having different geometries. FIG. 20 schematically depicts a flexible sidewall 2000, according to one or more aspects described herein. In one example, the flexible sidewall 2000 may be similar to the flexible sidewall 200, where similar numbers represent similar features of both sidewalls 200 and 2000. The sidewall 2000 additionally includes a left side notch 2002 at a bottom left corner of the flexible sidewall 2000, and a right side notch 2004 at a bottom right corner of the flexible sidewall 2000. Notches 2002 and 2004 may have triangular geometries or any other geometrical shapes, without departing from the scope of these disclosures The left side notch 2002 and the right side notch 2004 may be configured to fit around a portion of a shelf, such as shelf 110. In one example, each of the left side notch 2002 on the right side notch 2004 may have a length 2006 that measures 2 inches. In another example, length 2006 may range between 0.5 and 5 inches. The left side notch 2002 on the right side notch 2004 may each have a height 2008 that measures 1 inches. In another example, the height 2008 may range between 0.25 and 5 inches.

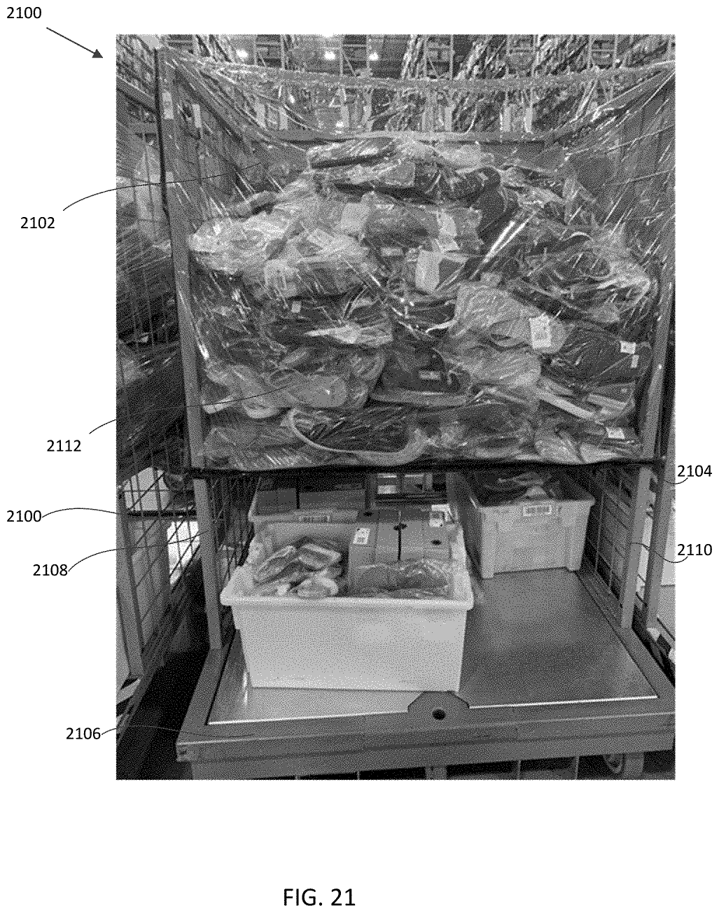

FIG. 21 depicts a container 2100 to which a retention and access system 2102 is removably coupled. The container 2100 may be similar to container 100, and the retention and access system 2102 may be similar to retention and access system 400. Further, FIG. 21 depicts the container 2100 having a shelf 2104. This shelf 2104 may be similar to shelf 110. The container 2100 also includes a base surface 2106 similar to base surface 108. In one example, the base surface 2106 extends out farther from sidewalls 2108 and 2110 than the shelf 2104. As depicted in FIG. 21, the retention and access system 2102 may be configured to retain various goods/items 2112 within the container 2100 and allow an opening into the container 2100 to be enlarged as the items 2112 are removed from the container 2100.

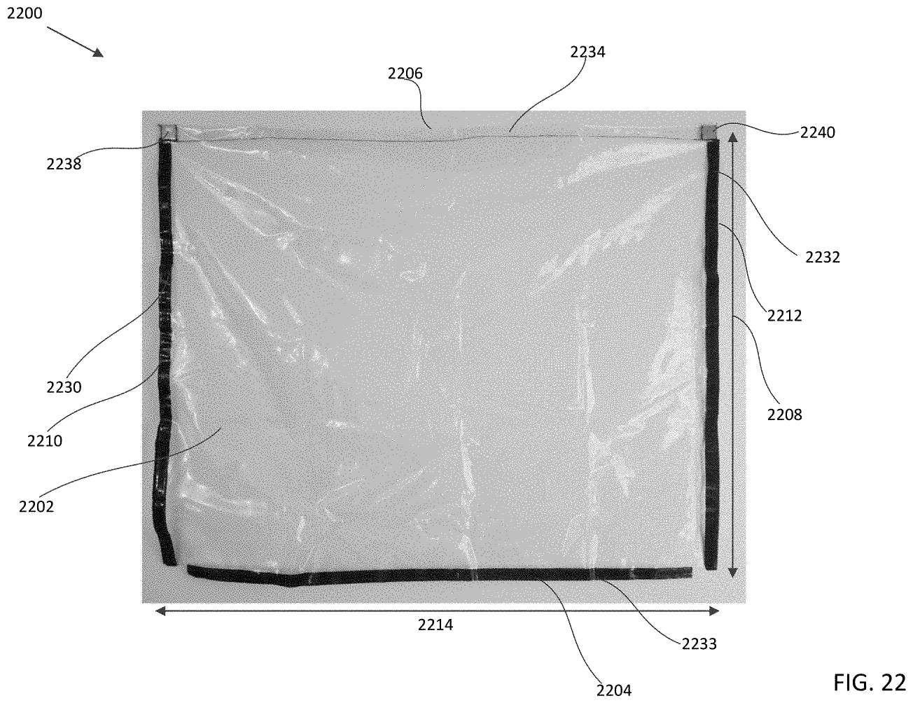

FIG. 22 depicts another implementation of a flexible sidewall 2200, according to one or more aspects described herein. The flexible sidewall 2200 may be similar to flexible sidewall 200. Accordingly, the flexible sidewall 2200 may be configured to be removably coupled to the open side 118 of the storage container 100. The flexible sidewall 2200 may include a panel 2202. The panel 2202 may have a bottom edge 2204 spaced apart from a top edge 2206 by a panel height/length 2208, and a left edge 2210 spaced apart from a right edge 2212 by a panel width 2214. The panel 2202 may be implemented with any height 2208 and width 2214. In one example, the width 2214 may be at least equal to width 102 of the container 100. In certain examples, the width 2214 may be greater than the width 102 such that portions of the panel 2202 may extend around to the sides of the container 100 and interact/removably couple with the strips 120 and 122. The height 2208 may be at least equal to the height 106. In other examples, the height 2208 may be less than or greater than the height 106. In certain specific examples, the width 2214 may be 52 inches, or may range between 45 and 60 inches. The height 2208 may range between 30 and 70 inches. However, it is contemplated that the flexible sidewall 2200 may be sized to fit different opening geometries of storage containers similar to container 100, without departing from the scope of these disclosures.

The flexible sidewall 2200 may additionally include a left side panel attachment strip 2230 that is flexibly coupled to the left edge 2210, and a right side panel attachment strip 2232 that is flexibly coupled to the right edge 2212 of the sidewall 2200. It is contemplated that any coupling mechanism or methodology may be utilized throughout this disclosure to facilitate rigid or flexible coupling, such as sewing, fabric welding, riveting, stapling, screwing, nailing, gluing, among others. The sidewall 2200 may additionally include a bottom side panel attachment strip 2233 that is flexibly coupled to the bottom edge 2204. The attachment strips 2230 and 2232, may be configured to be removably coupled to the attachment strips 120 and 122, respectively. The attachment strip 2233 may be configured to be removably coupled to the attachment strip 124 and/or 126. Accordingly, the attachment strips 2230, 2232, and 2233 may be implemented with the same attachment mechanism as the strips 120, 122, 124 and 126. The attachment strips 2230, 2232, and 2233 may be hook and loop fasteners, magnetic strips/discrete magnetic elements spaced apart along the strips 2230, 2232, and 2233, zippers or snaps, among others. It is further contemplated that attachment strips 2230, 2232, and 2233 may use differing fastening elements, without departing from the scope of these disclosures. For example, attachment strips 2230 and 2232 may utilize hook and loop fasteners to removably couple to attachment strips 120 and 122, and attachment strip 2233 may use a magnetic strip to attach to a magnetic strip of the attachment strip 124 or 126. In one example, if a magnetic strip is used in one or more of attachment strips 2230, 2232, and/or 2233, the container 100 may not need to be outfitted with a corresponding attachment strip 120, 122, 124 and/or 126 if the container 100 is formed from a magnetic material such that the magnetic strip of one or more of the attachment strips 2230, 2232, and/or 2233 may be magnetically coupled directly to the container 100.

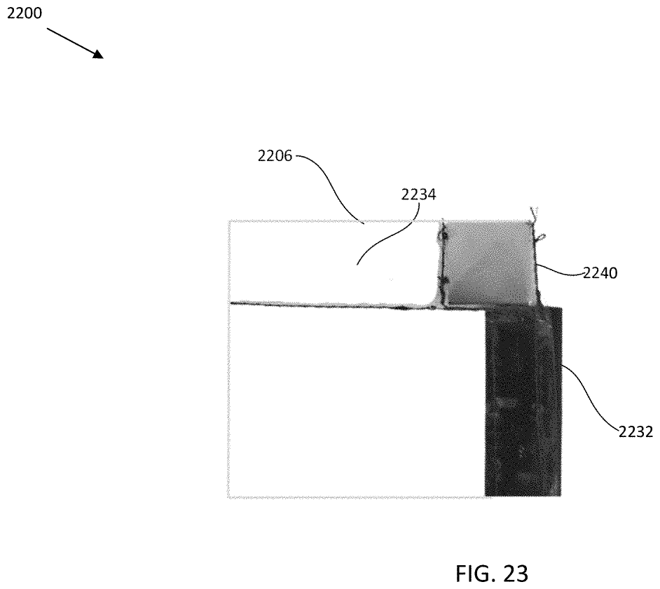

The sidewall 2200 may also include a top sleeve 2234 that is flexibly coupled to the top edge 2206. This top sleeve 2234 may comprise a double layer of material to provide a reinforced top edge 2206 of the sidewall 2200. In the depicted implementation of FIG. 22, the top sleeve 2234 may be a sealed top sleeve having a first magnetic coupler 2238 flexibly coupled to a left side of the top edge 2206 of the sidewall 2200 and a second magnetic coupler 2240 flexibly coupled to a right side of the top edge 2206 of the sidewall 2200. It is contemplated that the first magnetic coupler 2238 and the second magnetic coupler 2240 may be formed from any permanent magnet material of any strength and/or size. Further, the first magnetic coupler 2208 and the second magnetic coupler 2240 may be configured to be used in a manner similar to the first coupler 238 and the second coupler 240 discussed in relation to FIG. 2. Specifically, the first magnetic coupler 2238 may be magnetically coupled to a first portion of a left side of the container 100, such as one or more of the members that form the left wall 114 of the container 100. Similarly, the second magnetic coupler 2240 may be magnetically coupled to a second portion of a right side of the container 100, which as one or more of the members that form the right wall 112. FIG. 23 depicted a more detailed view of the second magnetic coupler 2240 flexibly coupled to the right side of the top edge 2206 of the sidewall 2200

It is contemplated that the structures described throughout this disclosure may be formed from any materials, or combination of materials. Further, the materials may have any material thicknesses, without departing from the scope of these disclosures. In one example, the panel 202 may be formed from a transparent vinyl material. In other examples, the panel may be formed from a partially transparent or opaque material. The material of the panel 202 may include one or more polymers, or canvas materials. It is further contemplated that the panel 202 may be formed from multiple layers of materials.

In one aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also have a first coupler flexibly attached to a left side of the top edge of the panel and a second coupler flexibly attached to a right side of the top edge of the panel, such that the first coupler is configured to be removably attached to a first portion of a left side of the container and the second coupler is configured to be removably attached to a second portion of a right side of the container. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

The first coupler and the second coupler may be configured to be uncoupled from the first and second portions of the container and coupled to a third portion on the left side of the container and a fourth portion on the right side of the container in order to access goods stored lower down in the container, such that the flexible sidewall may be configured to fold to allow the first coupler and the second coupler to be removably coupled to the third and fourth portions, respectively, of the container.

The retention and access system may also include a top sleeve flexibly coupled to the top edge of the panel. The top sleeve may be sealed at one or both ends.

The panel may have a window formed from a transparent vinyl material.

The panel may extend in a vertical plane at the open side of the storage container, and may be configured to retain goods within the storage container.

The first and second couplers may comprise magnets, ferromagnetic materials, snaps, hook and loop fasteners, or hooks.

The flexible sidewall may include a left side notch at a bottom left corner of the flexible sidewall and a right side notch at a bottom right corner of the flexible sidewall.

The left side container attachment strip may be coupled to the left edge of the open side of the storage container and the right side container attachment strip may be coupled to the right edge of the open side of the storage container by adhesive strips.

The left side container attachment strip may be coupled to the left edge of the open side of the storage container and the right side container attachment strip may be coupled to the right edge of the open side of the storage container by self-tapping screws.

In another aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also include a top sleeve that is flexibly attached to the top edge of the panel. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

The retention and access system may also include a first magnetic coupler that is flexibly attached to a left side of the top edge of the panel and a second magnetic coupler that is flexibly attached to a right side of the top edge of the panel, such that the first magnetic coupler may be configured to be magnetically coupled to a first portion of a left side of the container and the second magnetic coupler may be configured to be magnetically coupled to a second portion of a right side of the container.

The first magnetic coupler and the second magnetic coupler may include permanent magnets.

The first magnetic coupler and the second magnetic coupler may include ferromagnetic elements, and the first portion of the left side of the container and the second portion of the right side of the container may include permanent magnets.

The retention and access system may also include a closure mechanism extending from the top edge to the bottom edge of the panel, the closure mechanism configured to removably couple a left portion of the panel to a right portion of the panel, wherein the closure mechanism is partially or wholly opened to access the storage container.

The retention and access system may also include an elastic cord that is configured to extend through the top sleeve, such that the elastic cord has a first coupler at a first end and a second coupler at a second end. The first coupler may be configured to be removably coupled to a first portion of a left side of the container and the second coupler may be configured to be removably coupled to a second portion of a right side of the container.

According to one aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also include a top sleeve that is flexibly attached to the top edge of the panel, and an elastic cord that is configured to extend through the top sleeve. The elastic cord may have a first coupler at a first end and a second coupler at a second end, with the first coupler configured to be removably attached to a first portion of a left side of the container, and the second coupler configured to be removably attached to a second portion of a right side of the container. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

The retention and access system may also include a bottom side panel attachment strip that is flexibly attached to the bottom edge of the panel, and a bottom side container attachment strip that is attached to and extends along a bottom edge of the open side of the storage container, with the bottom side container attachment strip configured to be removably attached to the bottom side panel attachment strip.

The panel may also include a window formed from a transparent vinyl material.

The panel may extend in a vertical plane at the open side of the storage container and may be configured to retain goods within the storage container.

The left side panel attachment strip may be removably coupled to the left side container attachment strip and the right side panel attachment strip may be removably coupled to the right side container attachment strip by hook and loop fasteners.

The left side panel attachment strip and the right side panel attachment strip may include a hook fasteners, and the left side container attachment strip and the right side container attachment strip may include loop fasteners.

The left side panel attachment strip may be removably coupled to the left side container attachment strip and the right side panel attachment strip may be removably coupled to the right side container attachment strip by the zipper fasteners, by magnetic strip fasteners, and/or by snap fasteners.

The elastic cord of the retention and access system may be configured to be uncoupled from the first and second portions of the container and coupled to a third portion on the left side of the container in a fourth portion on the right side of the container in order to access goods stored lower down in the container, such that the flexible sidewall is configured to fold to allow the elastic cord to be coupled to the third and fourth portions of the container.

The flexible sidewall may also include a left side notch at a bottom left corner of the flexible sidewall and a right side notch at a bottom right corner of the flexible sidewall, such that the left side notch and the right side notch may be configured to fit around a portion of a shelf installed in the storage container.

According to another aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also have a first coupler flexibly attached to a left side of the top edge of the panel and a second coupler flexibly attached to a right side of the top edge of the panel, such that the first coupler is configured to be removably attached to a first portion of a left side of the container and the second coupler is configured to be removably attached to a second portion of a right side of the container. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

The first and second couplers may include hooks and/or spring-loaded swivel bolts.

The flexible sidewall may also include a left side notch at a bottom left corner of the flexible sidewall and a right side notch at a bottom right corner of the flexible sidewall, the left side notch and the right side notch may measure 1 inch in height and 2 inches wide. The panel height may be between 30 and 70 inches and the panel width may be between 45 and 60 inches.

The left side container attachment strip may be attached to the left edge of the open side of the storage container and the right side container attachment strip may be attached to the right edge of the open side of the storage container by self-tapping screws.

According to another aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment strip that is flexibly attached to the left edge of the panel, and a right side panel attachment strip that is flexibly attached to the right edge of the panel. The flexible sidewall may also have a first coupler flexibly attached to a left side of the top edge of the panel and a second coupler flexibly attached to a right side of the top edge of the panel, such that the first coupler is configured to be removably attached to a first portion of a left side of the container and the second coupler is configured to be removably attached to a second portion of a right side of the container. The flexible sidewall may also include a closure mechanism that extends from the top edge to the bottom edge of the panel, with the closure mechanism configured to removably attached to a left portion of the panel to a right portion of the panel, such that the closure mechanism is partially or wholly opened to access the storage container. The retention and access system for the storage container may also include a left side container attachment strip that is attached to and extends along a left edge of the open side of the storage container, with the left side attachment strip configured to be removably attached to the left side panel attachment strip. The retention and access system for the storage container may also have a right side container attachment strip that is attached to and extends along a right edge of the open side of the storage container, with the right side container attachment strip configured to be removably attached to the right side panel attachment strip.

According to one aspect, a retention and access system for a storage container may include a flexible sidewall that is configured to be removably attached to an open side of a storage container. The flexible sidewall may also include a panel that has a bottom edge that is spaced apart from a top edge by a panel height, and a left edge spaced apart from a right edge by a panel width. The flexible sidewall may also include a left side panel attachment that is attached to the left edge of the panel, and a right side panel attachment that is attached to the right edge of the panel. The flexible sidewall may also include a first coupler attached to a left side of the top edge of the panel, and a second coupler attached to a right side of the top edge of the panel, and the first coupler is configured to be removably attached to a first portion of a left side of the container, and the second coupler configured to be removably attached to a second portion of a right side of the container. The retention and access system for the storage container may also include a left side container attachment that is attached to and extends along a left edge of the open side of the storage container, with the left side attachment configured to be removably attached to the left side panel attachment strip. The retention and access system for the storage container may also have a right side container attachment that is attached to and extends along a right edge of the open side of the storage container, with the right side container attachment configured to be removably attached to the right side panel attachment.

According to another aspect, a method of forming a retention and access device for a storage container may include forming a flexible sidewall that is configured to be removably attached to an open side of a storage container. The method may also include forming a panel that has a bottom edge that is spaced apart from a top edge by a panel height, and a left edge spaced apart from a right edge by a panel width. The method may also include forming a left side panel attachment that is attached to the left edge of the panel, and a right side panel attachment that is attached to the right edge of the panel. The method may also include forming a first coupler attached to a left side of the top edge of the panel, and a second coupler attached to a right side of the top edge of the panel, and the first coupler is configured to be removably attached to a first portion of a left side of the container, and the second coupler configured to be removably attached to a second portion of a right side of the container. The method may include forming a left side container attachment that is attached to and extends along a left edge of the open side of the storage container, with the left side attachment configured to be removably attached to the left side panel attachment strip. The method may also include forming a right side container attachment that is attached to and extends along a right edge of the open side of the storage container, with the right side container attachment configured to be removably attached to the right side panel attachment.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

I/We claim:

1. A retention and access system for a storage container, comprising:
a flexible sidewall configured to be removably coupled to an open side of a storage container, the flexible sidewall further comprising:
a panel having a bottom edge spaced apart from a top edge by a panel height and a left edge spaced apart from a right edge by a panel width;
a left side panel attachment coupled to the left edge of the panel and a right side panel attachment coupled to the right edge of the panel;
a first coupler coupled to a left side of the top edge of the panel and a second coupler coupled to a right side of the top edge of the panel, wherein the first coupler is configured to be removably coupled to a first portion of a left side of the container and the second coupler is configured to be removably coupled to a second portion of a right side of the container;
a left side container attachment, coupled to and extending along a left edge of the open side of the storage container, the left side container attachment configured to be removably coupled to the left side panel attachment; and
a right side container attachment, coupled to and extending along a right edge of the open side of the storage container, the right side container attachment configured to be removably coupled to the right side panel attachment.

2. The retention and access system of claim 1, wherein the first coupler and the second coupler are configured to be uncoupled from the first and second portions of the container and coupled to a third portion on the left side of the container and a fourth portion on the right side of the container in order to access goods stored lower down in the container, wherein the flexible sidewall is configured to fold to allow the first coupler and the second coupler to be removably coupled to the third and fourth portions, respectively, of the container.

3. The retention and access system of claim 1, further comprising:
a top sleeve flexibly coupled to the top edge of the panel.

4. The retention and access system of claim 1, wherein the panel further comprises a window formed from a transparent vinyl material.

5. The retention and access system of claim 1, wherein the panel extends in a vertical plane at the open side of the storage container and is configured to retain goods within the storage container.

6. The retention and access system of claim 1, wherein the first and second couplers comprise magnets or ferromagnetic materials.

7. The retention and access system of claim 1, wherein the first and second couplers comprise a plurality of hooks or a plurality of loops.

8. The retention and access system of claim 1, the flexible sidewall further comprising:
a left side notch at a bottom left corner of the flexible sidewall and a right side notch at a bottom right corner of the flexible sidewall.

9. The retention and access system of claim 1, wherein the left side container attachment is coupled to the left edge of the open side of the storage container and the right side container attachment is coupled to the right edge of the open side of the storage container by adhesive strips.

10. The retention and access system of claim 1, wherein the left side container attachment is coupled to the left edge of the open side of the storage container and the right side container attachment is coupled to the right edge of the open side of the storage container by self-tapping screws.

11. A retention and access system for a storage container, comprising:
a flexible sidewall configured to be removably coupled to an open side of a storage container, the flexible sidewall further comprising:
a panel having a bottom edge spaced apart from a top edge by a panel height and a left edge spaced apart from a right edge by a panel width;
a left side panel attachment strip flexibly coupled to the left edge of the panel and a right side panel attachment strip flexibly coupled to the right edge of the panel;
a top sleeve flexibly coupled to the top edge of the panel;
a left side container attachment strip, coupled to and extending along a left edge of the open side of the storage container, the left side container attachment strip configured to be removably coupled to the left side panel attachment strip; and
a right side container attachment strip, coupled to and extending along a right edge of the open side of the storage container, the right side container attachment strip configured to be removably coupled to the right side panel attachment strip.

12. The retention and access system of claim 11, further comprising:
a first magnetic coupler coupled to a left side of the top edge of the panel and a second magnetic coupler coupled to a right side of the top edge of the panel, wherein the first magnetic coupler is configured to be magnetically coupled to a first portion of a left side of the container and the second magnetic coupler is configured to be magnetically coupled to a second portion of a right side of the container.

13. The retention and access system of claim 12, wherein the first magnetic coupler and the second magnetic coupler comprise permanent magnets.

14. The retention and access system of claim 12, wherein the first magnetic coupler and the second magnetic coupler comprise ferromagnetic elements, and the first portion of the left side of the container and the second portion of the right side of the container comprise permanent magnets.

15. The retention and access system of claim 11, further comprising:
a closure mechanism extending from the top edge to the bottom edge of the panel, the closure mechanism configured to removably couple a left portion of the panel to a right portion of the panel, wherein the closure mechanism is partially or wholly opened to access the storage container.

16. The retention and access system of claim 11, further comprising:
an elastic cord, configured to extend through the top sleeve, the elastic cord having a first coupler at a first end, and a second coupler at a second end, wherein the first coupler is configured to be removably coupled to a first portion of a left side of the container and the second coupler is configured to be removably coupled to a second portion of a right side of the container.

17. The retention and access system of claim 11, further comprising:
a bottom side panel attachment strip flexibly coupled to the bottom edge of the panel; and
a bottom side container attachment strip, coupled to and extending along a bottom edge of the open side of the storage container, the bottom side container attachment strip configured to be removably coupled to the bottom side panel attachment strip.

18. The retention and access system of claim 11, wherein the left side panel attachment strip is removably coupled to the left side container attachment strip and the right side panel attachment strip is removably coupled to the right side container attachment strip by hook and loop fasteners.

19. The retention and access system of claim 11, wherein the left side panel attachment strip is removably coupled to the left side container attachment strip and the right side panel attachment strip is removably coupled to the right side container attachment strip by magnetic strip fasteners.

20. A method of forming a retention and access device for a storage container, comprising:
forming a flexible sidewall configured to be removably coupled to an open side of a storage container, the forming of the flexible sidewall further comprising:
forming a panel having a bottom edge spaced apart from a top edge by a panel height and a left edge spaced apart from a right edge by a panel width;
forming a left side panel attachment coupled to the left edge of the panel and a right side panel attachment coupled to the right edge of the panel;
forming a first coupler coupled to a left side of the top edge of the panel and a second coupler coupled to a right side of the top edge of the panel, wherein the first coupler is configured to be removably coupled to a first portion of a left side of the container and the second coupler is configured to be removably coupled to a second portion of a right side of the container;
forming a left side container attachment, coupled to and extending along a left edge of the open side of the storage container, the left side container attachment configured to be removably coupled to the left side panel attachment; and
forming a right side container attachment, coupled to and extending along a right edge of the open side of the storage container, the right side container attachment configured to be removably coupled to the right side panel attachment.
